(19) United States
(12) Patent Application Publication
(10) Pub. No.: US 2010/0125609 A1
(43) Pub. Date: May 20, 2010

(54) Digital Comic and Sequential Art Multimedia File Format

(76) Inventors: Aaron Joseph Hazen, Tega Cay, SC (US); Adam Lee May, Huntersville, NC (US)

Correspondence Address: Aaron J. Hazen, 116 Amber Woods Dr., Tega Cay, SC, 29708, US

(21) Appl. No.: 12/581,036

(22) Filed: Oct. 16, 2009

Related U.S. Application Data
(60) Provisional application No. 61/114,842, filed on Nov. 14, 2008.

(51) Int. Cl. G06F 17/30; G06F 3/01

(52) U.S. Cl. 707/791; 707/E17.009; 715/730

(57) ABSTRACT

A multimedia file embedded on a computer readable storage medium has a file format comprising a file header section including metadata describing the multimedia file; and a file body section including a frame information section for each frame in a sequence of frames in the multimedia file.

### BACKGROUND OF THE INVENTION

The present invention generally relates to a digital file format that specifies a standard for storing sequential art, such as a comic book, in a single unified file type.

Currently, publishers, artists, and writers do not have a secure, unified file format that protects their sequential art content in a digital format. Consequently, copyright owners rely on formats such as CBR, CBZ, PDF, and CXP in order to encapsulate their content.

As can be seen, what is needed is a digital file format that specifies a standard for storing sequential art.

### SUMMARY OF THE INVENTION

In one aspect of the present invention, a multimedia file embedded on a computer readable storage medium has a file format comprising a file header section including metadata describing the multimedia file; and a file body section including a frame information section for each frame in a sequence of frames in the multimedia file.

These and other features, aspects and advantages of the present invention will become better understood with reference to the following drawings, description and claims.

### BRIEF DESCRIPTION OF THE DRAWINGS

FIG. 1 shows a block diagram of an exemplary file format in accordance with an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provides a Digital Comic and Sequential Art Multimedia File Format that specifies a standard for storing sequential still art such, as a comic book, in a single unified file type, thus providing a user experience of combined sound, animation, and still art in a creative bundle that adds to the traditional comic experience. The file format may support audio, video, animation, and metadata related to the sequential art or multi layered, time indexed, comic formats, and may also allow multiple media formats with individual digital rights to be bundled and presented in a consolidated media experience, enabling intellectual property to be registered in a media file library.

The multimedia file storing the sequential art may also conceptually mimic a physical comic book, such as by having one or more “pages” that have one or more “frames” of the sequential data, and by having information such as volume, issue, and year that are commonly found in physical comic books.

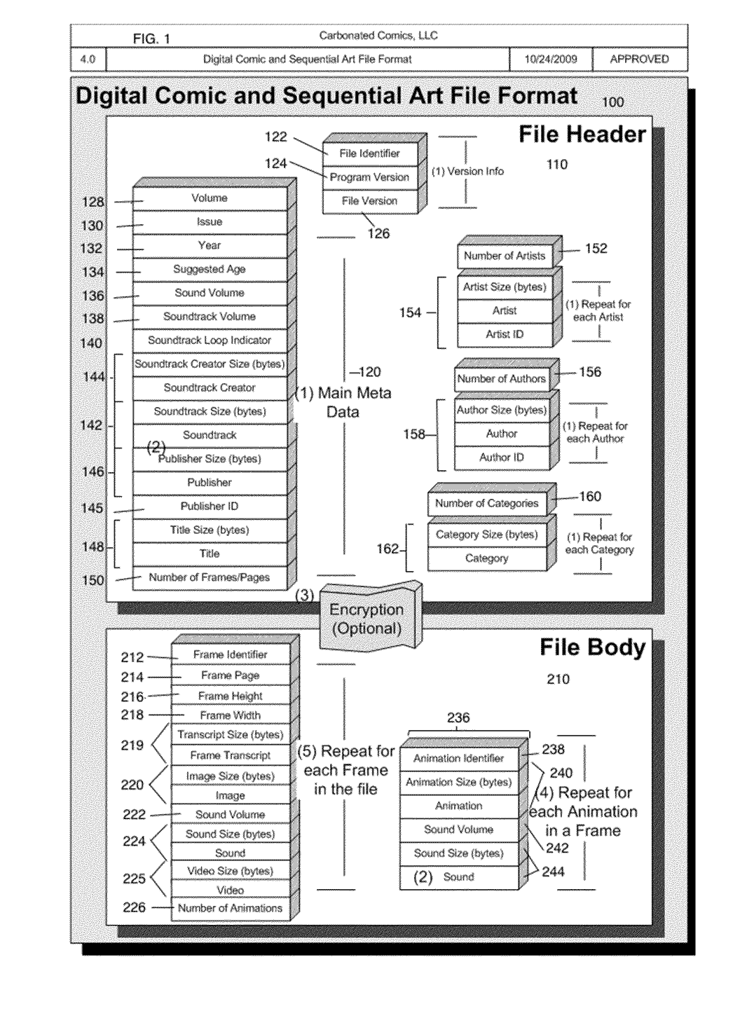

FIG. 1 illustrates an example of a file format for a digital comic and sequential art multimedia file in accordance with an embodiment of the present invention. The multimedia file 100 may be divided into two major functions: a file header section 110 and a file body section 210. The file header section 110 can include metadata 120 that describes the multimedia file 100 and defines the organization of the rest of the associated parts of the multimedia file 100 as well as additional information about the overall contents of the multimedia file 100.

The metadata 120 may include a unique file identifier 122, a program version 124 of the multimedia file 100, a file version 126, a number of frames 150 indicating the number of frames and/or pages contained within the multimedia file 100, volume 128, issue 130, year 132, suggested age 134, sound volume 136, soundtrack loop 140, soundtrack volume 138, soundtrack creator data 144, soundtrack data 142, publisher data 146, publisher ID 145, title data 148, number of artists 152, artist data 154 for each artist in the multimedia file 100, number of authors 156, author data 158 for each author in the multimedia file 100, number of categories 160, and category data 162 for each category in the multimedia file 100.

The file body section 210 may sequentially follow the file header section 110 in the multimedia file 100, and can contain the sequence of frames that define the content of sequential art contained within the multimedia file 100. The file body section 210 may also include encryption information for encrypting itself via use of standard encryption algorithms such as 3DES or SHA1, or via use of a proprietary implementation of encryption algorithms.

For each frame in the sequence of frames of the sequential art contained within the multimedia file 100, the file body section 210 can contain a frame information section containing a frame identifier 212 identifying the page the frame is grouped with, a frame page 214, a frame height 216, a frame width 218, frame transcript data 219, an image data 220, a sound volume 222, a sound data 224, video data 225, and the number of animations 226. For each animation in a frame, the frame information section may further include animation information 236 including an animation identifier 238, an animation data 240, an animation sound volume 242, and an animation sound data 244.

The components of the file format may be stored in a sequence within a single file, such as a CCX file. The sequence of data stored within the file may determine the level of security and protection imposed on the file. In an unprotected file, the header and body may be sequentially stored, with the header at the beginning of the file followed by the frames or pages in the body of the file. In a protected file, the bytes of the header and body may be intermingled and encrypted so as to obscure the implementation of the digital media, and to protect the owner's rights to the media. The file format is a specification of bytes within a file. Portions of the file format are sequential as the nature of the media using the format is sequential. In that sense, the sequence of frames, pages, metadata, audio, video, animation, and security measures may be re-ordered in other subjective ways. The file format may also be versioned in order to permit the growth of the format over time to support newer technologies and needs.

A file organized according to the file format described herein may be embodied upon computer readable storage medium and may be read by a “reader” program on a computer that consumes and presents the data contained therein. The reader can use the metadata contained within the file to display a summary of the file in an electronic user interface. The content or data for the sequence of frames stored within the file may be displayed as a visual and aural representation of each frame through whatever mechanisms are available to the reader, such as in a computer program, on a mobile phone, or on a video game console. The reader would be expected to decrypt the frames for presentation.

While the above-described embodiments of the present invention may relate to a file format for multimedia files storing sequential art, the above-described file format may also be used to support other digital, sequential media. For example, the format can be used to create medical journals with triggered audio for specific portions of the journal. The file format has been designed with a “frame” or “page” as the lowest common denominator, so that each page or frame can contain its own set of metadata, audio, animations, video, or other such information.

It should be understood, of course, that the foregoing relates to exemplary embodiments of the invention and that modifications may be made without departing from the spirit and scope of the invention as set forth in the following claims.

We claim:

1. A multimedia file, embodied upon computer readable storage medium, for storing sequential art, the multimedia file having a file format comprising:
a file header section including metadata describing the multimedia file; and
a file body section including frame information for each frame in a sequence of frames comprising the sequential art stored in the multimedia file.

2. The file format of claim 1, wherein the metadata further comprises:
a version info including a unique file identifier, a program identifier, a file version, and an indication of the number of frames to be described in the file body section.

3. The file format of claim 1, wherein the frame information for a frame further comprises:
an animation information section including animation data for an animation in the frame.

4. The file format of claim 1, wherein the frame information section for a frame further comprises:
a set of bytes defining sequential still art for the frame;
data for the sequential still art for the frame; and
page data indicating a page that the frame is grouped with.

5. The file format of claim 1, wherein the file body section is encrypted.

6. A multimedia comic book file, embodied upon computer readable storage medium, including sequential art for presentation, the multimedia comic book file having a file format comprising:
a file header section including metadata describing the multimedia comic book file and indicating the number of a plurality of sequential still art frames contained within the multimedia comic book file; and
a file body section including frame information for each sequential still art frame in the plurality of sequential still art frames in the multimedia comic book file, a frame information for a sequential still art frame including:
frame data;
still art image data;
video data;
audio data; and
an animation information section containing animation data for each of a plurality of animations in the frame.

7. The multimedia comic book file of claim 6, wherein the metadata further comprises a unique file identifier, a program identifier, and a file version.

8. The multimedia comic book file of claim 6, wherein the frame information for a frame further comprises an indication of a page the frame is grouped with.

9. A computer implemented method for displaying a multimedia comic book file embodied upon computer readable storage medium, the method comprising:
reading a file header section of a multimedia comic book file having metadata describing the multimedia comic book file;
displaying a summary of the multimedia comic book based on the metadata;
reading a file body section of the multimedia comic book file that sequentially follows the file header section in the multimedia comic book file, the file body section having frame information for each frame of sequential still art stored within the multimedia comic book file;
displaying a visual and aural representation of each frame of sequential still art stored within the multimedia comic book file based on frame information for each frame of sequential still art stored within the multimedia comic book file.

10. The method of claim 9, wherein the displaying a visual and aural representation further comprises displaying an animation included within a frame information for a frame in the sequential still art stored within the multimedia comic book file.
